(19) United States
(12) Patent Application Publication
(10) Pub. No.: US 2012/0302265 A1
(43) Pub. Date: Nov. 29, 2012

(54) VEHICLE TELEMATICS COMMUNICATION FOR PROVIDING VEHICLE TELEMATICS SERVICES

(75) Inventors: Yao Hui Lei, Windsor (CA); Sethu K. Madhavan, Erie, PA (US); Kenneth L. Peirce, Grosse Pointe Farms, MI (US); Ki Hak Yi, Windsor (CA)

(73) Assignee: GENERAL MOTORS LLC, Detroit, MI (US)

(21) Appl. No.: 13/114,324

(22) Filed: May 24, 2011

(51) Int. Cl. H04W 4/14

(52) U.S. Cl. 455/466

(57) ABSTRACT

A method and system for providing a communication message to a vehicle occupant using a vehicle telematics unit. The method carried out by the system involves receiving a broadcasted message having a plurality of different codes at a vehicle telematics unit, generating a text message by converting at least some of the codes into one or more words, and concatenating the words together to form the text message. The method further involves presenting the text message to an occupant of the vehicle.

### TECHNICAL FIELD

The present invention relates generally to vehicle telematics services and, more specifically, to providing text message communications to vehicles for presentation to its operator or other occupant.

### BACKGROUND OF THE INVENTION

Mobile phone technology is increasingly used to provide a variety of services to mobile phone users. One of the services provided is cell broadcast which involves broadcasting a message from one point such as a network station to a geographical area where several network subscribers can receive an alert message over their mobile phones for example. This can be beneficial especially in an emergency case where a certain geographical location is affected by a natural disaster for example. However, the alert message is limited to a certain number of characters (e.g., 93 characters). In addition, some mobile phones may not have the capability to support cell broadcast or have it activated.

### SUMMARY OF THE INVENTION

According to one embodiment of the invention, there is provided a method of providing a communication message to a vehicle occupant using a vehicle telematics unit, comprising the steps of: (a) wirelessly receiving a communication message having a plurality of different codes that is sent using a character-limited communication protocol; (b) confirming the authenticity of the communication message; (c) decoding the communication message by mapping each of at least some of the codes to one or more words and then combining the words together into a decoded communication message; and (d) providing the decoded communication message to an occupant of the vehicle.

According to another embodiment of the invention, there is provided a method of providing a communication message to a vehicle occupant using a vehicle telematics unit, comprising the steps of: (a) receiving a broadcasted message having a plurality of different codes at a vehicle telematics unit; (b) generating a text message by converting at least some of the codes into one or more words and concatenating the words together to form the text message; and (c) presenting the text message to an occupant of the vehicle.

According to another embodiment of the invention, there is provided a telematics unit for a vehicle for providing a vehicle occupant with a communication message, wherein the telematics unit includes a processor and computer readable memory that contains instructions that are executed by the processor to carry out the following steps: (a) receiving a broadcasted message having a plurality of different codes at a vehicle telematics unit; (b) generating a text message by converting at least some of the codes into one or more words and concatenating the words together to form the text message; and (c) presenting the text message to an occupant of the vehicle.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein;

FIG. 2 is a flowchart illustrating some steps of an exemplary embodiment for sending a secure coded communication message;

FIG. 3 is an illustrative diagram depicting an embodiment of a method of encoding a communication message and may be used with the exemplary embodiment illustrated in FIG. 2; and

FIG. 4 is a flowchart of an exemplary method of providing a communication message to a vehicle occupant using a vehicle telematics unit.

### DETAILED DESCRIPTION OF THE ILLUSTRATED EMBODIMENT(S)

The system and methods described below provide a communication message to a vehicle occupant using a vehicle telematics unit. This involves generating a communication message such as a warning message, an alert message, and/or any other type of message. Later, the communication message is packaged to an appropriate format such as a short message and sent to its destination. The packaging of the communication message can involve encoding and security techniques as described herein. Once received at the vehicle telematics unit, the communication message can be decrypted, decoded, and finally presented to an occupant of the vehicle. Further details are presented in the next sections.

### Communications System—

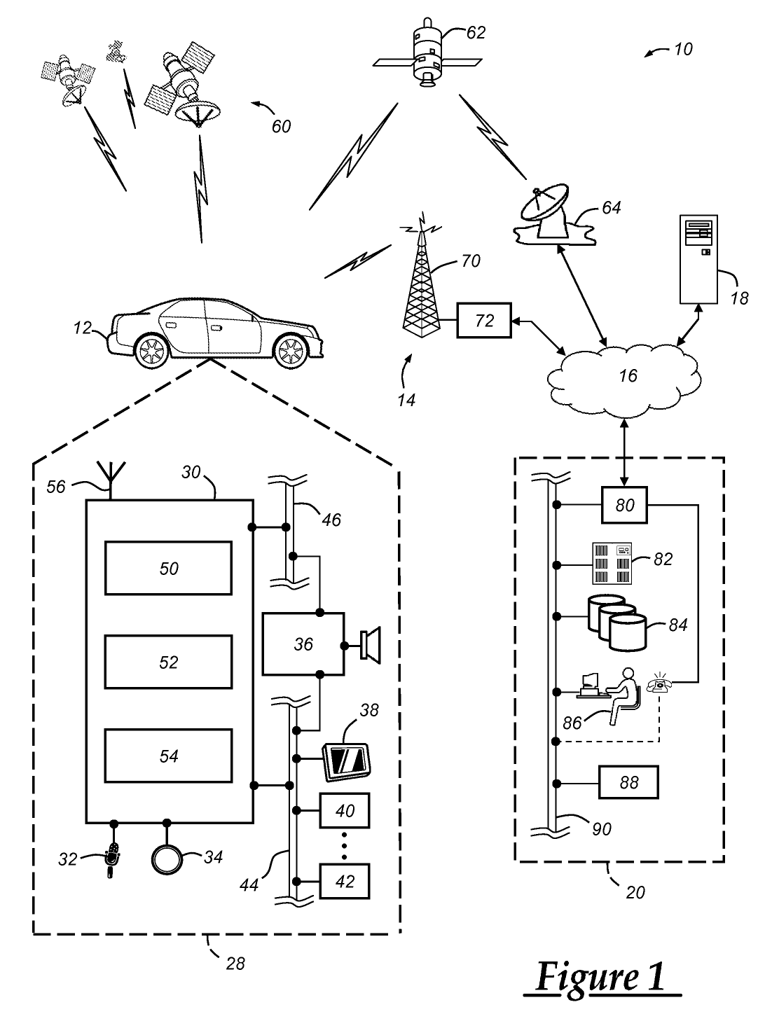

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is wired into the vehicle electronics 28 and that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. If used, the Bluetooth connection may employ any technology known by skilled artisans including frequency hopping spread spectrum, Gaussian frequency shift keying (GFSK), etc. In one such embodiment, the telematics unit 30 can be paired with a nearby device such as a mobile phone 22 using frequency hopping spread spectrum radio technology at the Industrial, Scientific and Medical (ISM) 2.4 GHz frequency band. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Apart from computer 18, other types of remotely located processing devices can be used. For example, a mobile communication device 22 can be used and can be one of a number of such communication devices used by subscribers. Each mobile device 22 is a processing device that can be used for one or more purposes, such as voice communication, text messaging, email, web browsing, gaming, camera, video recording, sending and receiving photos and videos, audio player (e.g., MP3), radio, GPS navigation, personal organizer, to name but a few. In the illustrated embodiment, mobile device 22 is a mobile phone such as a cell phone that connects to a cellular network such as system 14. In another embodiment, mobile device 22 can be a personal digital assistant (PDA) that has wireless communication ability, but may or may not be equipped to provide telephony services itself. Mobile device 22 communicates wirelessly with the vehicle 12 by any suitable technology; for example, via a Bluetooth connection between the mobile device 22 and telematics unit 30. Other than mobile phones and PDAs, various other types of suitable processing devices can be used as the mobile device 22.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

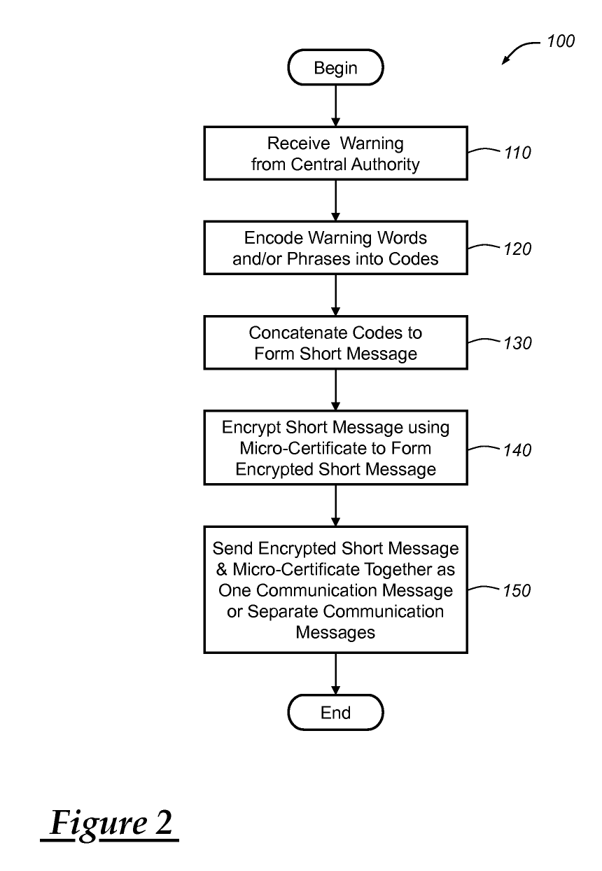

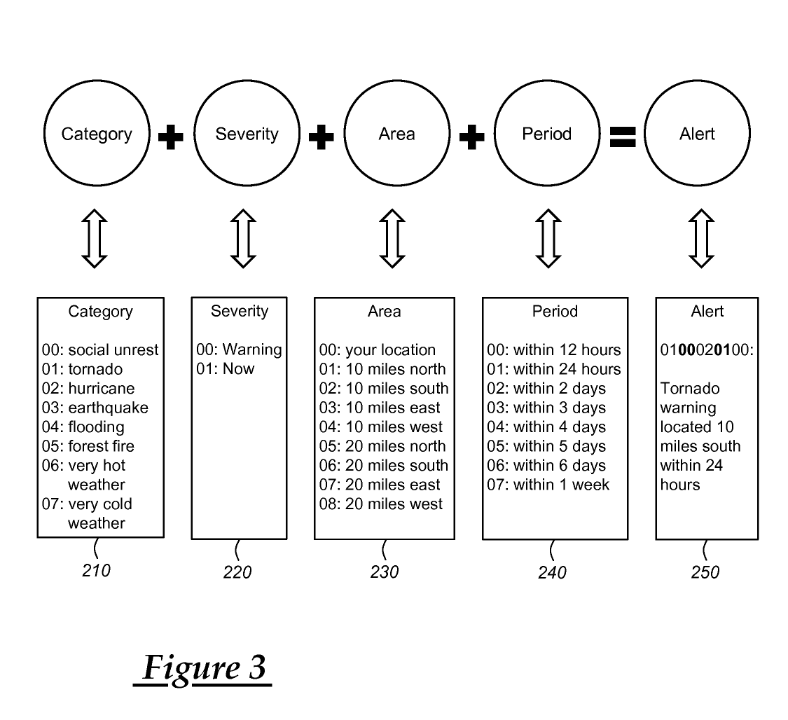

Turning now to FIG. 2, there is shown an exemplary embodiment of a method 100 for sending a secure coded communication message to a vehicle telematics unit, such as telematics unit 30 discussed above. In this exemplary embodiment, the method generates a communication message such as a warning message, an alert message, and/or any other type of message. Then, method 100 packages the communication message to an appropriate format. Once the communication message is formulated, method 100 sends the communication message to its destination. The following explanation of exemplary method 100 is provided in conjunction with the flowchart shown in FIG. 2 and the diagram shown in FIG. 3 which depicts one method of encoding a communication message that may be used with the exemplary embodiment illustrated in FIG. 2

The method 100 starts at step 110 and begins by receiving a warning from an alert authority. In this step, method 100 may receive or gather information from any one or more of a variety of sources including a weather service authority, a public safety authority, a road traffic authority, a disaster or emergency authority, etc. The alert authority can be a local (e.g., citywide, statewide, etc.) or national authority (e.g., nationwide or countrywide), a single or a network of authorities (e.g., Red Cross/Red Crescent), a national (e.g., U.S. Department of Homeland Security (DHS), U.S. Federal Emergency Management Agency (FEMA), etc.) or an international organization (e.g., Red Cross/Red Crescent, United Nations, etc.), etc. The alert subject can be of any topic that may be of interest to an occupant of vehicle 12 including alerts about social unrest, weather condition (e.g., tornado, hurricane, flooding, very hot or cold weather, etc.), natural disaster (e.g., earthquake, fire, etc.), and/or other alert types. The alert received may vary depending in the event severity and may be described as advisory, watch, warning, etc. The alert may also cover a specific area (e.g., current location, 10 miles north, 10 miles south, etc.) and may provide an occurrence time (e.g., now, within few minutes, within few hours, within few days, etc.). Other information can be also provided. Skilled artisans should appreciate that the alert messages can cover other topics in addition to warnings such as entertainment, cultural, and/or other topics that may be of interest to an occupant of vehicle 12. In one embodiment, the occupant may be interested in a football game score, weather forecast, election result, stock price, etc.

Next, at step 120, method 100 encodes the words and/or phrases of an alert or warning text into codes. Skilled artisans should appreciate that encoding the words and/or phrases of an alert shortens the message of a character-limited communication protocol. Therefore, it provides an advantage of sending a longer message using less characters and for some embodiments provides room in the SMS message to send a micro-certificate for authentication purposes. FIG. 3 shows one embodiment for encoding alert words into codes. In this embodiment, the alert is composed of various parts where each part has a set of codes. For example, part 210 which is event category includes a “00” code for “social unrest”, a “01” code for “tornado”, a “02” code for “hurricane”, etc. Part 220 is event severity and includes codes such as “00” for “warning” and “01” for “now”. Part 230 is event area and includes codes such as “00” for “your location” (i.e., vehicle occupant), “01” for “10 miles north”, etc. Part 240 is event period and includes codes such as “00” for “within 12 hours”, “01” for “within 24 hours”, etc. Skilled artisans should appreciate that other messages and corresponding codes are also possible and that FIG. 3 shows only one potential example. For example, part 220, event severity can include other subparts and corresponding codes such as “02” for “watch”, “03” for “advisory”, etc. In addition, part 240, event period can have different subparts in addition to or instead of the ones shown such as “08” for “within 15 minutes”, “09” for “within 30 minutes”, “10” for “within 60 minutes”, etc. Furthermore, the codes can be alphanumeric (e.g., base 16 hexadecimal (0-F), base 32 hexadecimal (0-V), etc.) versus the numeric ones shown in FIG. 3, one character, two character codes as shown in FIG. 3, and/or other format that will produce a shorter encoding of words or phrases of an alert message. A lookup table or other suitable approach can be used to encode the words into codes.

At step 130, method 100 concatenates the codes to form a short message. In one embodiment, the codes are concatenated in the same order that the words or phrases are encoded to form a short message. FIG. 3 box 250 shows one example of an alert message where the words “tornado”, “warning”, “10 miles south”, and “within 24 hours” corresponding codes “01”, “00”, “02”, and “01” are concatenated to “01000201”. In this case, the concatenation technique used attaches one code to the end of another code until all codes are attached to form a string of codes. However, other concatenation techniques can be also employed to concatenate two or more codes to form a short message including a software command or function commonly used to assemble several codes together. Skilled artisans should appreciate that a message containing the string “01000201” is much shorter than a string containing the words “Tornado warning in 10 miles south within 24 hours”.

At step 140, method 100 encrypts the short message to form a secure short message. In one embodiment, method 100 uses a micro-certificate technique to form an encrypted short message. Skilled artisans should appreciate that using a micro-certificate technique will assist in keeping the message short since a micro-certificate is small by design as described in US Patent Application Publication number US2010/0202616 A1. Other encryption techniques can be employed; however, a micro-certificate or a similar technique has the advantage of preserving the small size factor of the message.

At step 150, method 100 sends the encrypted short message to its destination. In one embodiment, the encrypted short message and a micro-certificate are sent together as one communication message. In another embodiment, the encrypted short message and the micro-certificate are sent separately in different communication message. However, before sending the communication message, in one embodiment, call center 20 can package the short message in a broadcast type short message service (SMS) message and later call center 20 broadcasts the SMS message via wireless carrier systems 14 to the telematics unit 30 of the vehicle 12 as well as other vehicles similarly equipped. These are only few examples as others will become obvious to skilled artisans.

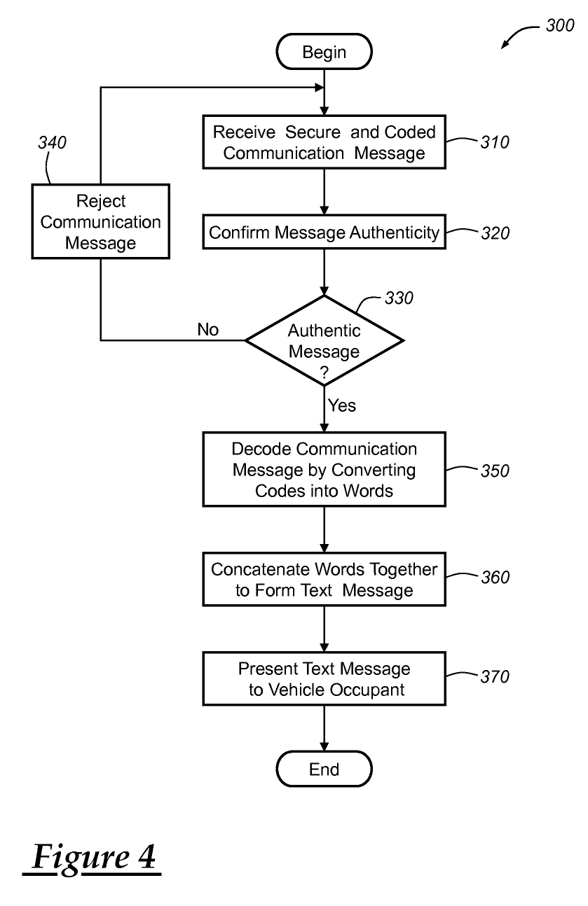

Turning now to FIG. 4, there is shown an exemplary embodiment of a method 300 of providing a communication message to a vehicle occupant using a vehicle telematics unit. The method starts at step 310 and begins by receiving a secure and coded communication message. In one embodiment, telematics unit 30 receives an SMS message broadcasted by call center 20 via wireless carrier systems 14 as described herein. In addition, the communication message can be secured using any of the security measures described herein. Furthermore, the communication message is coded to shorten its length.

Next, at step 320, method 300 confirms the authenticity of the communication message. Skilled artisans should appreciate that the authenticity of the communication message is checked to insure reliable and accurate information is provided to an occupant of vehicle 12. Furthermore, this step can be used to detect and ignore any malicious or otherwise unauthorized communication messages received by vehicle 12. In one embodiment, processing device 52 compares one or more identifiers of the communication message source including a phone number of call center 20 to a list of stored identifiers in memory 54. In another embodiment, processing device 52 decrypts the communication message via a set of public and private keys of a micro-certificate technique. Skilled artisans will recognize the decryption techniques employed herein and therefore a lengthy description is avoided. In any case, by the end of this step, method 300 confirms the communication message received at vehicle 12.

Then, at step 330 if the communication message is found to be not authentic then it will be rejected by telematics unit 30 (step 340) and method 300 loops back to its beginning However, if the communication message is found to be authentic then method 300 proceeds to the next step.

At step 350, the communication message is decoded from codes to words. This step is opposite to the previously described step 120. In step 120, the message words were encoded into codes; however, in step 350 the codes are decoded back into words. In one embodiment, processor 52 decodes the communication message using a lookup table stored in memory device 54. The lookup table can be similar to the one used by call center 20 to encode the communication message into codes. For instance as shown in FIG. 3, “01” is decoded into “tornado”, “00” into “warning”, “02” into “10 miles south”, and “01” into “within 24 hours”. This is only one illustrative example as others are also possible.

Next, at step 360, method 300 concatenates the decoded words together to form a text message. This step is similar to the previously described step 130. In step 130, codes were concatenated; however, in step 360 words are concatenated to form a text message. The decoded words can be combined together to form a sentence and certain words such as “located”, etc. can be added to form the sentence. In addition, different words can be added or subtracted depending n which codes are received. Continuing with the previous example shown in FIG. 3, the recently decoded codes into words can be concatenated by processor 52 to form the following message, “Tornado warning located 10 miles south within 24 hours”. Here the word “located” has been automatically added by processor 52 using its programming stored in memory 54. In addition, processor 52 can also implement correct punctuation and appropriate grammar in this step as well via any available and suitable text editing software, for example.

Finally, at step 370, method 300 presents the text message to an occupant of vehicle 12. The text message can be presented using any video, visual, audio, and/or other technique. In one embodiment, display 38 shows the text message to an occupant of vehicle 12. In another embodiment, audio system 36 converts the text message to an audio message and plays it to an occupant of vehicle 12. In another embodiment, audio system 36 plays a warning sound followed by playing either a visual or audio representation of the text message. In another embodiment, audio system 36 or call center 20 can play a message requesting to play an important message to an occupant of vehicle 12. Skilled artisans should appreciate that other embodiments are also possible.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the telematics unit can be implemented using different modules on the vehicle that perform different ones or parts of the various functions described above. For example, one module of the telematics unit could handle short range communication with the occupant's mobile device, a second module can handle the vehicle user interfaces, including speech recognition and speech synthesis, with a third module of the telematics unit handling wireless communication with the call center via a cellular or other wireless communication system. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing a communication message to a vehicle occupant using a vehicle telematics unit, comprising the steps of:
(a) wirelessly receiving a communication message having a plurality of different codes that is sent using a character-limited communication protocol;
(b) confirming the authenticity of the communication message;
(c) decoding the communication message by mapping each of at least some of the codes to one or more words and then combining the words together into a decoded communication message; and
(d) providing the decoded communication message to an occupant of the vehicle.

2. The method of claim 1, wherein the communication message is a broadcasted SMS message received from a call center via a wireless cellular communication network.

3. The method of claim 1, wherein the communication message is a secure communication message encrypted using a micro-certificate.

4. The method of claim 1, wherein the coded communication message is an alphanumeric code.

5. The method of claim 1, wherein step (b) further comprises confirming the authenticity of the communication message using a micro-certificate.

6. The method of claim 1, wherein each of the codes corresponds to a different part of a sentence and wherein step (c) further comprises converting each of the codes by looking up the one or more words in memory at the vehicle using the codes.

7. The method of claim 6, wherein step (c) further comprises the step of forming the decoded communication message by concatenating the words to thereby form the sentence.

8. The method of claim 7, wherein the forming step further comprises concatenating the words in the order in which the associated codes were contained in the coded communication message.

9. A method of providing a communication message to a vehicle occupant using a vehicle telematics unit, comprising the steps of:
(a) receiving a broadcasted message having a plurality of different codes at a vehicle telematics unit;
(b) generating a text message by converting at least some of the codes into one or more words and concatenating the words together to form the text message; and
(c) presenting the text message to an occupant of the vehicle.

10. The method of claim 9, wherein the broadcasted message is an encrypted message.

11. The method of claim 9, wherein the broadcasted message is an SMS message.

12. The method of claim 9, wherein the method further comprises prior to step (a), the step of receiving a micro-certificate at the telematics unit, and wherein step (a) further comprises receiving the broadcasted message as an encrypted, coded message using the micro-certificate.

13. The method of claim 9, wherein step (a) further comprises receiving a micro-certificate and the broadcasted message together as a single communication message, wherein the broadcasted message is encrypted using the micro-certificate.

14. The method of claim 9, wherein the method further comprises prior to step (b), the steps of decrypting the broadcasted message and confirming the authenticity of the broadcasted message.

15. The method of claim 9, wherein step (b) further comprises concatenating the words in the order in which the associated codes were contained in the coded communication message.

16. The method of claim 15, wherein the decoded message is an alert message.

17. A telematics unit for a vehicle for providing a vehicle occupant with a communication message, wherein the telematics unit includes a processor and computer readable memory that contains instructions that are executed by the processor to carry out the following steps:
(a) receiving a broadcasted message having a plurality of different codes at a vehicle telematics unit;
(b) generating a text message by converting at least some of the codes into one or more words and concatenating the words together to form the text message; and
(c) presenting the text message to an occupant of the vehicle.

18. A vehicle telematics unit as defined in claim 17, wherein the telematics unit memory stores a decoding key that decodes the broadcasted message.
